(19) United States
(12) Patent Application Publication
(10) Pub. No.: US 2004/0203687 A1
(43) Pub. Date: Oct. 14, 2004

(54) Mobile communication terminal and method of adding a dictionary thereto

(75) Inventor: Yuka Hasegawa, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/396,328

(22) Filed: Mar. 26, 2003

(30) Foreign Application Priority Data
Mar. 27, 2002 (JP) 089167/2002

(51) Int. Cl. H04M 3/00

(52) U.S. Cl. 455/418; 455/412.1

(57) ABSTRACT

A mobile communication terminal having, in addition to a conversation function, a function of inputting data from another medium, and a function of sending and receiving an electronic mail of the present invention includes a first and a second memory. The first memory stores dictionary data received from another medium. The second memory stores a copy of the dictionary data when characters are to be edited.

### BACKGROUND OF THE INVENTION

1. Field of the Invention

The present invention relates to a mobile personal telephone or similar mobile communication terminal having a communication function using an electronic mail. More particularly, the present invention relates to a method capable of easily adding dictionary data to a mobile communication terminal in the event of composition of an electronic mail or similar character editing.

2. Description of the Background Art

Today, interchanging electronic mails by use of a portable personal telephone or similar mobile communication terminal is a daily experience. Another daily experience is inputting data in such a mobile communication terminal. In these circumstances, it is extremely important to implement rapid, easy input of characters in a mobile communication terminal. In practice, however, a dictionary customarily installed in, e.g., a mobile personal telephone contains only vocabulary of daily use as distinguished from, e.g., technical terms used in special businesses or fields.

Japanese Patent Laid-Open Publication No 7-273853, for example, discloses a portable personal telephone storing a conversion dictionary and capable for the conversion of kana (Japanese syllabary) to kanji (Chinese character) However, the kana-to-kanji conversion dictionary is fixedly stored in a memory together with a program that controls the telephone. Therefore, new vocabulary cannot be added to the telephone without the entire program being rewritten.

Although the user of the above telephone may use an extra dictionary other than the kana-to-kanji conversion dictionary stored in the telephone, the user cannot do so without inputting it in the telephone by time- and labor-consuming work. Further, many vocabularies cannot be easily registered at the telephone because the number of dictionaries that can be registered is limited.

Technologies relating to the present invention are also disclosed in, e.g., Japanese Patent Laid-Open Publication No. 2001-346259.

### SUMMARY OF THE INVENTION

It is therefore an object of the present invention to provide a mobile communication terminal allowing a new dictionary desired by the user of the terminal to be easily added, and a method of adding the new dictionary to the terminal.

A mobile communication terminal having, in addition to a conversation function, a function of inputting data from another medium, and a function of sending and receiving an electronic mail of the present invention includes a first and a second memory. The first memory stores dictionary data received from another medium. The second memory stores a copy of the dictionary data when characters are to be edited.

### BRIEF DESCRIPTION OF THE DRAWINGS

The above and other objects, features and advantages of the present invention will become more apparent from the following detailed description taken with the accompanying drawings in which:

FIG. 1 is a schematic block diagram showing a mobile communication terminal embodying the present invention;

FIG. 2 shows a structure in which dictionary data are stored in a first and a second memory included in the illustrative embodiment;

FIG. 3 is a flowchart demonstrating a specific sequence available with the illustrative embodiment for downloading new dictionary data;

FIG. 4 is a flowchart showing a specific sequence also available with the illustrative embodiment for storing the downloaded dictionary data;

FIG. 5 is a flowchart showing a sequence available for the user of the terminal to cancel a setting for using the dictionary data;

FIG. 6 is a flowchart demonstrating a specific sequence further available with the illustrative embodiment for registering dictionary data read out of a storage medium at the terminal.

### DESCRIPTION OF THE PREFERRED EMBODIMENT

Briefly, a mobile communication terminal of the present intention has, in addition to a conversation function, a function of inputting data from another medium and a function of sending and receiving electronic mails, browsing electronic mails and composing or otherwise editing characters for electronic mails. As for the function of inputting data from another medium, the terminal can download a file or data from a browser or similar network or copy a file or data stored in a flexible disk or similar storage medium. Particularly, the terminal of the present invention can obtain dictionary data for kana-to-kanji conversion from another medium and store them in an internal memory. Only if the user of the terminal inputs a setting for using the dictionary data as a kana-to-kanji dictionary, technical terns or similar special vocabulary can be easily added to the terminal.

It is to be noted that character editing refers to the composition of an electronic mail, input of information on a schedule table, input of data in a memo pad, input of a title to be added to a telephone number or similar work for inputting data in the form of characters or symbols.

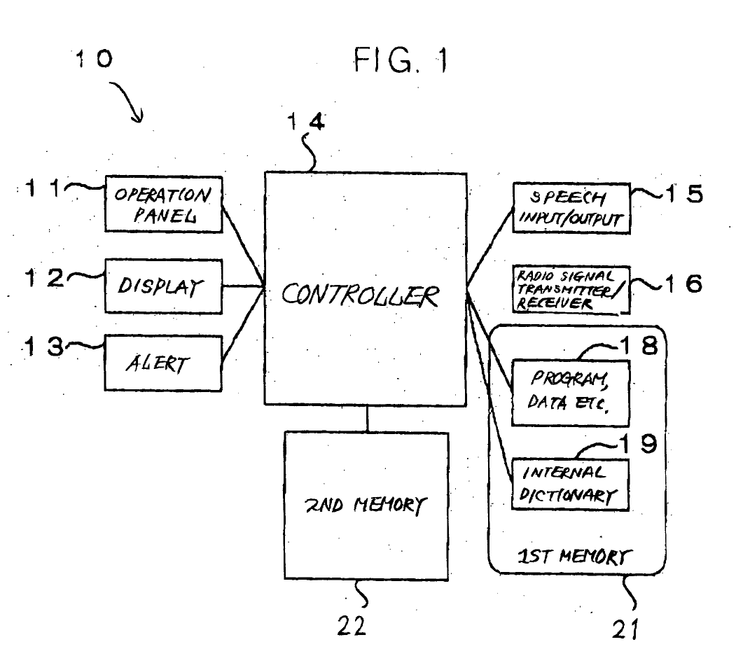

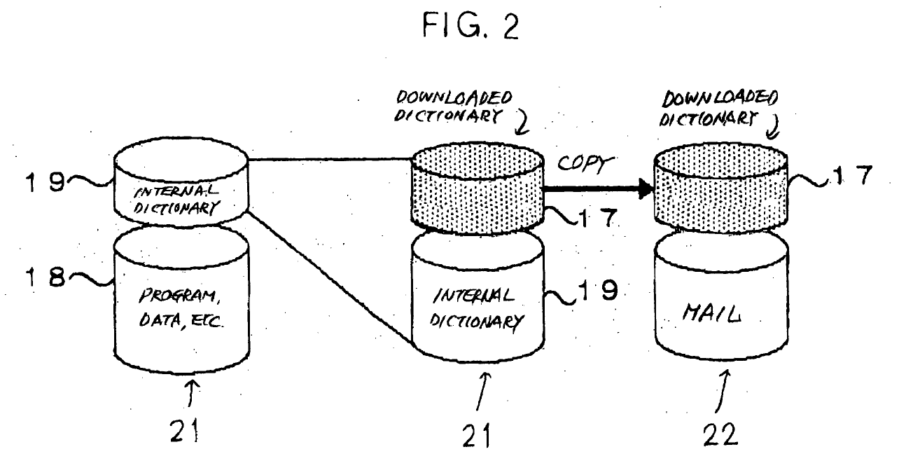

Referring to FIG. 1 of the drawings, a mobile communication terminal embodying the present invention is shown and implemented as a portable personal telephone by way of example. As shown, the portable personal telephone (simply telephone hereinafter), generally 10, includes an operation panel 11 on which a keyboard, ten keys and other data inputting devices are arranged. A display 12 is implemented as an LCD (Liquid Crystal Display) and displays data input by the user of the telephone or received data. An alert section 13 includes a speaker for alerting the user to a call incoming and a change in the status of the telephone 10. A controller 14 is implemented as a CPU (Central Processing Unit) for controlling the operation panel 11, display 12 and alert unit 13. A speech is input to or output from the telephone 10 via a speech input/output section 15. A radio signal transmitter/receiver 16 sends or receives a radio signal. A first memory 21 stores a program 18 necessary for the operation of the telephone 10 and various data including downloaded dictionary data 17 (see FIG. 2) and internal dictionary data 19. A second memory 22 is used to copy the downloaded data 17 therein.

As stated above, the telephone 10 has, in addition to a conversation function, a function of downloading files and data from a browser or similar network and a character editing function. With the character editing functions the telephone 10 can send or receive electronic mails, browse electronic mails or prepare documents for electronic mails.

Reference will be made to FIG. 2 for describing the storage structure of the first and second memories 21 and 22. As shown, when the telephone 10 newly downloads dictionary data 17 desired by the user via a network, the dictionary data 17 are written to the first memory 21. Subsequently, when the user, intending to compose an electronic mail, inputs the user's intention to use the downloaded dictionary data 17, the dictionary data 17 are copied in the second memory 22, as will be described more specifically later. The user then composes an electronic mail by using the dictionary data 17 copied in the second memory 22. At this instant, the user can, of course, use the internal dictionary 19 in addition to the downloaded dictionary data 17.

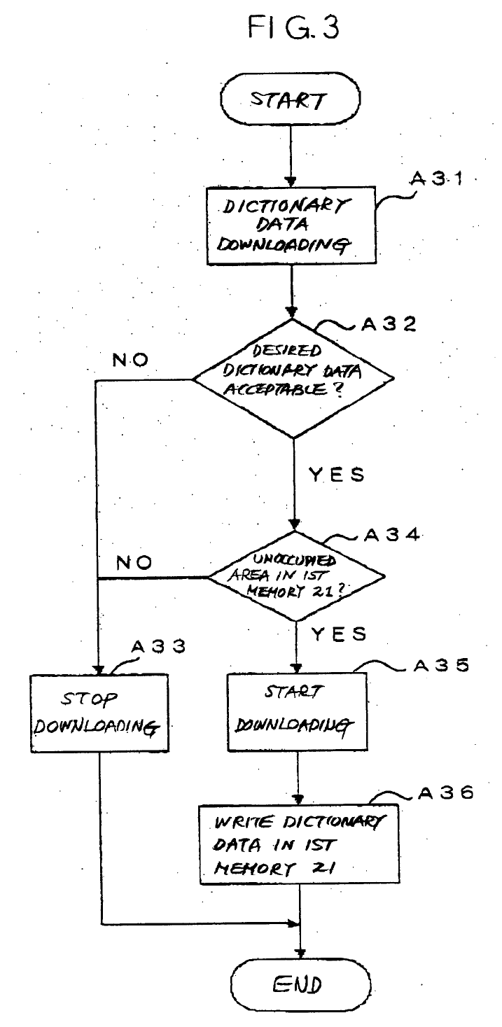

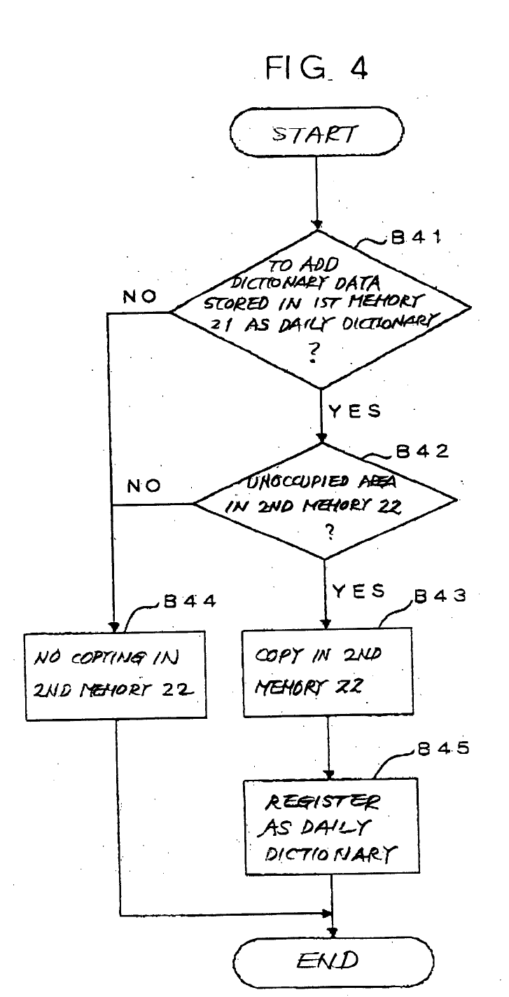

FIG. 3 is a flowchart demonstrating a specific sequence in which the telephone 10 newly downloads dictionary data. FIG. 4 is a flowchart showing how the downloaded dictionary data are stored in the telephone 10. A procedure for adding new dictionary data to the telephone 10 will be described with reference to FIGS. 3 and 4 hereinafter.

As shown in FIG. 3, when the user of the telephone 10 inputs the user's intention to download desired dictionary data (step A31), the controller 14 first determines whether or not the desired dictionary data are acceptable as dictionary data (step A32). If the answer of the step A32 is positive (YES), then the controller 14 determines whether or not the first memory 21 has an unoccupied area large enough to store the dictionary date (step A34). If the answer of the step A34 is YES, then the controller 14 starts downloading the dictionary data (step A35). The dictionary data 17 thus downloaded are written to the first memory 21 (step A36).

If the answer of the step A32 or that of the step A34 is negative (NO), meaning that the desired dictionary data are not acceptable or that the first memory 21 has no room to store the dictionary data 17, then the controller 14 does not execute downloading (step A33).

As shown in FIG. 4, after the dictionary data 17 have been stored in the first memory 21 (step A36, FIG. 3), the controller 14 inquires the telephone 10 whether or not the downloaded dictionary data 17 should be registered as a dictionary of daily use (step B41). For this purpose, the controller 14 may display an inquiry message on the display 12. Assume that the user inputs an answer indicating that the user will use the dictionary data 17 as a daily dictionary on the operation panel 11 (YES, step S41). Then, the controller 14 determines whether or not the second memory 22 has an unoccupied area large enough to store the dictionary data 17 (step B42). If the answer of the step B42 is YES, then the controller 14 copies the dictionary data 17 in the second memory (step B43) to thereby register the data 17 as a daily dictionary.

When the user does not desire to use the dictionary data 17 as a daily dictionary (NO, step B41) or when the second memory 22 is full (NO, step B42), the controller 14 does not copy the dictionary data 17 in the second memory 22 (step B44). On the other hand, when the user desires to use the dictionary data 17 as a daily dictionary (YES, step B41), the data 17 stored in the second memory 22 are used, but the data 17 stored in the first memory 22 are not used.

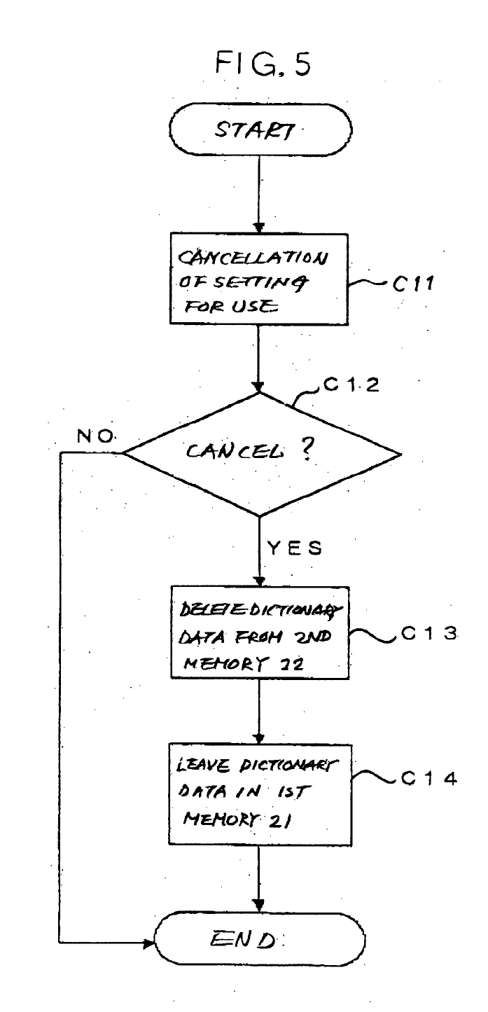

FIG. 5 demonstrates a specific sequence in which the user cancels the setting for using the dictionary data 17 stored in the second memory 22 as a daily dictionary. As shown, the user inputs the intention to cancel such a setting in the controller 14 via the operation panel 11 (step C11). For this purpose, the user may press preselected one of the various keys arranged on the operation panel 11.

After the step C11, the controller 14 displays, for a reconfirmation purpose, a message inquiring the user whether or not the above setting should be canceled on the display 12 (step C12). If the user inputs a positive answer to the inquiry (YES, step C12), then the controller 14 deletes the dictionary data 17 stored in the second memory 22 (step C13). However, the dictionary data 17 stored in the first memory 21 are preserved (step C14). The dictionary data 17 can therefore be copied in the second memory 22 and reused whenever the user needs them in the future.

The user may delete even the dictionary data 17 stored in the first memory 21 when they are not necessary any more. In this case, the dictionary data 17 stored in the second memory 22 are deleted together with the above dictionary data, i.e., the dictionary data 17 are practically deleted in the telephone 10.

As stated above, by downloading additional dictionary data from a network, the telephone 10 can easily add new vocabulary without rewriting the internal dictionary 19. Also, the conventional procedure that requires the user to register conversion candidates absent in an internal dictionary at the dictionary is not necessary. Further, the downloaded dictionary data 17 are stored in the first memory 21 and then copied in the second memory 22 at the time of use. It is therefore possible for the user to cancel the setting for using the dictionary data 17 and delete the data 17 stored in the second memory 22 for thereby easily excluding unnecessary vocabulary from the subjects of kana-to-kanji conversion.

Furthermore, when the dictionary data 17 stored in the second memory 22 are deleted, information stored in the internal dictionary 19 can be updated at the same time. This makes it possible to obviate mismatching between the internal dictionary 19 and the dictionary data 17 or to enrich the contents of the internal dictionary 19.

Moreover, in the event of search for kana-to-kanji conversion, the controller 14, remembering the procedure for copying the dictionary data 17 of the first memory 21 in the second memory 22, searches only the second memory 22. This successfully solves the problem that kana-to-kanji conversion speed is lowered.

While the foregoing description has concentrated on a portable personal telephone, the illustrative embodiment is similarly applicable to a PDA (Personal Digital Assistant). With a PDA, it is possible not only to download the dictionary data 17, but also to obtain them from a Smart Media (trade name) or similar storage medium, as will be described hereinafter.

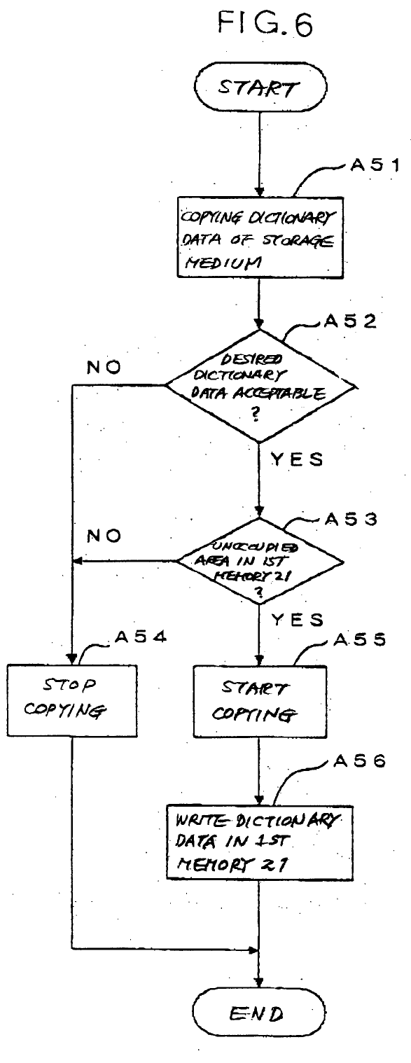

FIG. 6 shows a specific procedure in which the dictionary date 17 read out of a storage medium are registered at the mobile communication terminal 10. As shown, when the user of the terminal 10 desires to use dictionary data stored in a storage medium as an additional dictionary (step A51), the controller 41 first determines whether or not the dictionary data are acceptable as a dictionary (step A52). If the answer of the step A52 is YES, then the controller 41 determines whether or not the first memory 21 has an unoccupied area large enough to store the dictionary data (step A53). If the answer of the step A53 is YES, then the controller 14 starts copying the dictionary data (step A55). The dictionary data 17 thus read out are written to the first memory 21 (step A56).

If the answer of the step A52 or that of the step A53 is negative (NO), meaning that the desired dictionary data are not acceptable or that the first memory 21 has no room to store the dictionary data 17, then the controller 14 does not copy the dictionary data (step A54).

After the dictionary data 17 have been copied in the first memory 21, the controller 14 determines whether or not the dictionary data 17 can be copied in the second memory 22 as in the procedure described with reference to FIG. 4. The user may cancel the setting for using the dictionary data 17 stored in the second memory 22 in the same manner as in the procedure of FIG. 5.

It is to be noted that the storage medium referred to in the specification may be any one of a CD-ROM (Compact Disk Read Only Memory), PD (Phase change optical Disk) or similar disk, a magnetic tape, an MO (Magneto Optical Disk), a DVD-ROM (Digital Video Disk ROM), a DVD-RAM (DVD Random Access Memory), flexible disk, a RAM, ROM or similar memory chip, an EPROM (Erasable Programmable ROM), an EEPROM (Electrically Erasable Programmable ROM), a Smart Media (trade name), a flash memory, a compact flash (trade name) card or similar rewritable card ROM, and a hard disk. Further, any other means is applicable to the illustrative embodiment so long as it is feasible for the storage of a program or data.

While the dictionary data 17 copied in the second memory 22 have been shown and described as being used to prepare a composition for an electronic mail, such an application is only illustrative. For example, the dictionary data 17 may be used to write information on a schedule table stored in the telephone 10 beforehand, to write various data in a memo pad also stored in the telephone 10 beforehand or to select, when storing the other party's telephone number or similar data in a memory, a title to be attached to the telephone number and displayed In this manner, the dictionary data 17 can be used when the user inputs data in the telephone 10 in the form of characters or symbols.

In summary, in accordance with the present invention, dictionary data storing desired vocabulary are downloaded from a network to a mobile communication terminal or registered at the communication terminal from a storage medium. The vocabulary can therefore be easily added to the communication terminal without an internal dictionary originally stored in the communication terminal being rewritten. The communication terminal can therefore use both of the internal dictionary and additional dictionary and can therefore detect more candidates than conventional. In addition, it is possible to update technical terms, words in fashion or similar special vocabulary.

Because dictionary data can be downloaded from a network, the conventional procedure that requires the user to register conversion candidates absent in the internal dictionary at the dictionary is not necessary. Further, the downloaded dictionary data are stored in a first memory and then copied in a second memory at the time of use. It is therefore possible for the user to cancel the setting for using the dictionary data and delete the data stored in the second memory for thereby easily excluding unnecessary vocabulary from the subjects of kana-to-kanji conversion.

Moreover, the dictionary data downloaded in the first memory are copied in the second memory in accordance with the scene in which the communication terminal is used. Therefore, when the user cancels the setting for using the downloaded dictionary data, only the dictionary data stored in the second memory are deleted. The dictionary data left in the first memory can be again copied in the second memory any time.

Various modifications will become possible for those skilled in the art after receiving the teachings of the present disclosure without departing from the scope thereof.

What is claimed is:

1. A mobile communication terminal having a conversation function, a function of inputting data from another medium, and a function of sending and receiving an electronic mail, said mobile communication terminal comprising:
a first memory configured to store dictionary data received from the another medium; and
a second memory configured to store a copy of the dictionary data when characters are to be edited.

2. The terminal as claimed in claim 1, wherein the another medium comprises a network, and
said terminal downloads a file or data from the network and stores said file or said data in said first memory.

3. The terminal as claimed in claim 2, wherein the dictionary data stored in said first memory are copied in said second memory when a user of said terminal inputs a setting for using said dictionary memory.

4. The terminal as claimed in claim 3, wherein when the dictionary data are not necessary any more, the user cancels the setting for using said dictionary data, whereby said dictionary data stored in said second memory are deleted while said dictionary data stored in said first memory are left.

5. The terminal as claimed in claim 1, wherein the another medium comprises a storage medium, and
said terminal copies a file or data stored in the storage medium and stores said file or said data in said first memory.

6. The terminal as claimed in claim 5, therein the dictionary data stored in said first memory are copied in said second memory when a user of said terminal inputs a setting for using said dictionary memory.

7. The terminal as claimed in claim 6, wherein when the dictionary data are not necessary any more, the user cancels the setting for using said dictionary data, whereby said dictionary data stored in said second memory are deleted while said dictionary data stored in said first memory are left.

8. The terminal as claimed in claim 1 wherein the dictionary data stored in said first memory are copied in said second memory when a user of said terminal inputs a setting for using said dictionary memory.

9. The terminal as claimed in claim 8, wherein when the dictionary data are not necessary any more, the user cancels the setting for using said dictionary data, whereby said dictionary data stored in said second memory are deleted while said dictionary data stored in said first memory are left.

10. A method of inputting dictionary data to be used for editing characters in a mobile communication terminal, said method comprising:
a first step of determining whether or not data to be input are acceptable as dictionary data;
a second step of determining whether or nor a first memory has an idle area large enough to store the dictionary data;
a third step of inputting, if the dictionary data are acceptable and if said first memory has the idle area, the dictionary data in said terminal and storing said dictionary data in said first memory;
a fourth step of determining whether or not a second memory has an idle area large enough to store the dictionary data; and
a fifth step of storing, if said second memory has the idle area, the dictionary data in said second memory.

11. The method as claimed in claim 10, wherein the third step comprises downloading the dictionary data from a network.

12. The method as claimed in claim 11, wherein the third step comprises copying the dictionary data from a storage medium.

13. The method am claimed in claim 12, wherein the dictionary data are written to said second memory only when a user of the mobile communication terminal inputs a setting for using said dictionary data.

14. The method as claimed in claim 13, wherein when the dictionary data are not necessary any more, the user cancels the setting for using said dictionary data, whereby said dictionary data stored in said second memory are deleted while said dictionary data stored in said first memory are left.

15. The method as claimed in claim 11, wherein the dictionary data are written to said second memory only when a user of the mobile communication terminal inputs a setting for using said dictionary data.

16. The method as claimed in claim 15, wherein when the dictionary data are not necessary any more, the user cancels the setting for using said dictionary data, whereby said dictionary data stored in said second memory are deleted while said dictionary data stored in said first memory are left.

17. The method as claimed in claim 10, wherein the dictionary data are written to said second memory only when a user of the mobile communication terminal inputs a setting for using said dictionary data.

18. The method as claimed in claim 17, wherein when the dictionary data are not necessary any more, the user cancels the setting for using said dictionary data, whereby said dictionary data stored in said second memory are deleted while said dictionary data stored in said first memory are left.
